(19) United States
(12) Patent Application Publication
(10) Pub. No.: US 2008/0309037 A1
(43) Pub. Date: Dec. 18, 2008

(54) NESTABLE SHOPPING CART WITH A REAR WHEELS LIFTER SYSTEM

(75) Inventor: Rene Hebert, Montreal (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: CARI-ALL PRODUCTS INC., Pointe-aux-Trembles (CA)

(21) Appl. No.: 12/135,301

(22) Filed: Jun. 9, 2008

Related U.S. Application Data
(60) Provisional application No. 60/929,079, filed on Jun. 12, 2007.

(51) Int. Cl. B62D 39/00

(52) U.S. Cl. 280/33.992

(57) ABSTRACT

The present invention concerns nestable shopping carts including a lifter mechanism allowing the rear wheels of each cart to rise when they are nested together in order to facilitate their displacements when forming a line and to limit the wear of rear wheels. The lifter system comprises the wheeled chassis of the cart having a front end section sloping downwardly from a line of junction. The chassis also comprises a rear cross-bar that may pass above the line of junction of a following similar cart. The lifter system can be easily modified to cancel its rising property in that it also comprises a height adapter removably connectable to the cross-bar for reducing, when connected to the cross-bar, the height of the bottom surface of the cross-bar causing the rear end of the chassis to lift when a following similar shopping cart is nested into the shopping cart.

### CROSS REFERENCE TO RELATED APPLICATION

This application claims the benefit of U.S. Provisional Application No. 60/929,079 filed on Jun. 12, 2007.

### FIELD OF THE INVENTION

The present invention pertains to nestable shopping carts including a lifter mechanism allowing the rear wheels of each cart to rise when they are nested together in order to facilitate their displacements when forming a line and to limit the wear of rear wheels.

### DESCRIPTION OF THE PRIOR ART

Most commonly, a shopping cart is designed to nest into a preceding identical cart and to enable a following identical cart to be nested into the shopping cart itself. In retail stores and their parking areas, long lines of nested shopping carts are generally formed, and moved by store employees.

The frame of a typical shopping cart commonly supports one or more baskets and has at least two front and two rear wheels, or casters. In general, the rear wheels do not swivel whereas the front wheels do, allowing the cart user to lead the shopping cart. Moving a line of nested shopping carts however stresses the rear wheels and their related components, thereby causing a fast wearing, particularly when attempts are made to turn the line of nested carts.

Raising the rear wheels when the carts are nested avoid any ground contact and facilitate the displacements of the cart lines by eliminating directions restrictions imposed by rear fixed wheels. Moreover, the life span of the rear wheels is increased because they are no longer subjected to lateral displacements which cause friction.

U.S. patent application published under No. 2004/0046341 A1 to WILKINSON (2004), and U.S. Pat. No. 3,015,494 to FOSBROOK; U.S. Pat. No. 4,647,055 to WEILL; U.S. Pat. No. 6,923,456 B2 to RYAN et al. and U.S. Pat. No. 7,216,875 B2 to O'QUIN, disclosed “nestable” shopping carts having rear wheels lift mechanism.

One drawback encountered with the shopping carts of the prior art reside in the presence of supplementary components of their lifting mechanism. This leads to a manufacturing cost increase of the carts. Also these mechanical parts are prone to break prematurely by fatigue failure or by handling the cart roughly.

Another drawback encountered with shopping carts of the prior art reside in that the mechanism is generally permanently fixed to the frame and cannot be easily removed from it. Cancelling the lift properly may be very useful, for example, when the ground surface of the parking area is steep.

There is thus still a need for an improved less expensive and more versatile lifting system for nestable shopping carts.

### SUMMARY OF THE INVENTION

An object of the present invention is to provide a nestable shopping cart that satisfies the above-mentioned need.

In accordance with the present invention, that object is achieved with a shopping cart nestable into a preceding similar shopping cart and into which a following similar shopping cart is nestable.

The shopping cart of the invention comprises a wheeled chassis having a rear end of width L₁, a rear end section, a front end section sloping downwardly from a line of junction between the rear end section and the front end section and a front end of width L₂ smaller that width L₁. The line of junction is positioned at a height h₂ above ground level. A rear cross-bar is provided in the rear end section of the chassis having a bottom surface positioned at a height h₁ above ground level greater than h₂, such that when a following similar shopping cart is nested into the shopping cart, the rear cross-bar passes above the line of junction of the following similar cart.

The shopping cart of the invention also includes a height adapter removably connectable to the cross-bar for reducing, when connected to the cross-bar, the height of the bottom surface of the cross-bar to a height h₃ which is smaller than height h₂ and thereby causing the rear end of the chassis to lift when a following similar shopping cart is nested into the shopping cart and the cross-bar reaches at least the line of junction of the following similar cart.

An advantage of the present invention with respect to what already exists on the market is that the shopping cart can be easily converted from a shopping cart with lift mechanism to a shopping cart without lift mechanism. Indeed, if the rising of the rear wheels is not desired, the height adapter may be simply removed from the rear cross-bar. Then, the manufacturer only has one cart model to manufacture and not two different models including or not the lift mechanism. The client may then decide to add or not the height adapter. The height adapter is added to the rear cross-bar when the lift of the rear wheels lifting is desired. The additions of supplementary mechanical components such as blocking cams or located chassis protuberance are not required anymore and the risks of breakage or loss of requisite parts for accurate functioning are eliminated.

Another advantage is that the shopping carts production and inventory control are simplified because the required number of components is reduced and that their design is not complex, the costs for manufacturing a shopping cart according to the invention are greatly lowered.

Preferably, the chassis further comprises at least one upright member extending from a point located on the rear end section. The upright member allows the rear cross-bar to be stopped when a preceding similar shopping cart is nested into the shopping cart. Also, the upright member may be useful for supporting the basket(s) of the shopping cart.

Preferably, the height adapter is tube-shaped and fixable to the rear cross-bar. More preferably, the height adapter comprises two half cylinders that are clippable to each other to form a tube embracing the rear cross-bar. For example, the two half cylinders may be similar and comprise a first and a second half cylinder each comprising a male planar longitudinal face provided with projections and a female planar longitudinal face provided with recesses sized to tightly receive the projections. The two half cylinders are then clippable to each other by connecting the male planar face and female planar face of the first half cylinder to the female planar face and male planar face respectively of the second half cylinder. The projections mentioned above may be barbed.

The invention is not limited by the shape or the number of height adapters removably connected to the cross-bar. As an example, the height adapter may comprise two height adapters, both of them being removably connectable to a respective extremity of the rear cross-bar.

The rear end section of the chassis is preferably sloping upwardly from the rear end to the line of junction. In that preferred configuration, the line of junction between the upward rear end section and the downward front end section forms a summit, of height h₂, defining a niche in association with the upward rear end section of the chassis and the upright member fixed behind the line of junction. The niche has a height h₄ slightly smaller than h₂ but greater than the height h₃. All the height h₁ to h₄ are measured from ground level.

As can be appreciated, when a shopping cart (hereinafter referred as to the rear shopping cart) is nested into another shopping cart provided with the height adapter (hereinafter referred as to the front shopping cart), the rear wheels of the front shopping cart are firstly caused to lift thanks to its height adapter, supported by the rear cross-bar, sliding on the slopping front section of the rear shopping cart, until the height adapter reaches the line of junction, or summit, of the rear shopping cart. Then, the rear wheels of the front cart are caused to lower down thanks to its height adapter and rear cross-bar sliding down on the rear end section of the rear shopping cart, until they reach and are stopped by the upright element of the rear shopping cart.

It results from this preferred embodiment of the invention that the sliding motion of the rear cross-bar of the front shopping cart on the rear section of the rear shopping cart is stopped by the upright element. Then, thanks to the effect of gravity and the fact that the rear end section of the rear shopping cart is rising toward the line of junction, the rear wheels of the front shopping cart are forced to remain in the lift position. The two nested shopping carts are thus temporarily linked together with the rear wheels of the front shopping cart remaining elevated until someone forces the disengagement of the two nested carts.

In case the store employees prefer not to use the lift system, the height adapter may be simply removed from the cross-bar. The height h₁ of the cross-bar being greater than the height h₂ of the line of junction, and then higher than the height h₄ of the niche, the cross-bar does not slide on the slopping front section of the rear shopping cart, the rear wheels of the front cart remaining then grounded.

All materials used in the making of the present invention are those generally used in the art of shopping carts or the like. In particular, the height adapter is preferably made of a plastic, but other sort of material may be used. More preferably, the plastic used may be Nylon® (i.e. polyamides) or ABS (i.e. Acrylonitrile Butadiene Styrene).

In accordance with another aspect of the invention, the object mentioned above is also achieved with a shopping cart comprising a wheeled chassis having a rear end of width L₁, a rear end section, a front end section sloping downwardly from a line of junction between the rear end section and the front end section and a front end of width L₂ smaller that width L₁. The line of junction is positioned at a height h₂ above ground level.

The chassis further comprises two spaced-apart longitudinal members extending from the rear end to the front end of the chassis and a front cross-bar connecting the two longitudinal members at the front end of the chassis.

A rear cross-bar is also provided in the rear end section of the chassis between the two longitudinal members and having a bottom surface positioned at a height h₁ above ground level greater than h₂, such that when a following similar shopping cart is nested into the shopping cart, the rear cross-bar passes above the line of junction of the following similar car.

Further provided are two upright members, each one being connected to one of the longitudinal members and extending from a point behind the line of junction for stopping the rear cross-bar of a preceding similar shopping cart being nested into the shopping cart.

In this embodiment, the shopping cart also includes two removable tube-shaped height adapters each one being fixable to an extremity of the rear cross-bar. Each one of the height adapters comprises two half cylinders that are clippable to each other to form a tube embracing the rear cross-bar for reducing, when connected to the rear cross-bar, the height of the bottom surface of the rear cross-bar to a height h₃ which is smaller than height h₂ and thereby causing the rear end of the chassis to lift when a following similar shopping cart is nested into the shopping cart and the cross-bar reaches at least the line of junction of the following similar cart.

As can be appreciated, when a shopping cart (hereinafter referred as to the rear shopping cart) is nested into another shopping cart (hereinafter referred as to the front shopping cart), the rear wheels of the front shopping cart are caused to lift thanks its rear cross-bar, including the height adapter, sliding on the sloping front section of the rear shopping cart until the cross-bar passes behind the line of junction of the rear shopping cart.

The present invention is not limited to the conception of shopping carts and may be adapted to the conception of other type of nestable carts.

The invention and its advantages will be better understood upon reading the following preferred embodiment made with reference to the accompanying drawings.

### BRIEF DESCRIPTION OF THE DRAWINGS

FIG. 1 is a perspective view of a shopping cart according to a preferred embodiment of the invention.

FIG. 2 is a perspective view of the rear part of the chassis of the shopping cart illustrated in FIG. 1, with the wire netting support removed for clarity purposes.

FIGS. 3A is an enlarge perspective view of a removable height adapter present on the shopping cart of FIG. 1, the height adapter being made of two half identical sections illustrated on FIG. 3B.

FIG. 4 is a side view of two shopping carts, as the one illustrated in FIG. 1, nested together, the front cart comprising two height adapters and its rear wheels then being lifted.

FIG. 5 is an enlarged view of the encircled portion V in dotted lines in FIG. 4.

FIG. 6 is a side view of the two shopping carts shown in FIG. 4, except that in this figure the front cart does not include the two height adapters, the rear wheels of the front then remaining grounded.

FIG. 7 is an enlarged view of the encircled portion VI in dotted lines in FIG. 6.

### DETAILED DESCRIPTION OF THE DRAWINGS

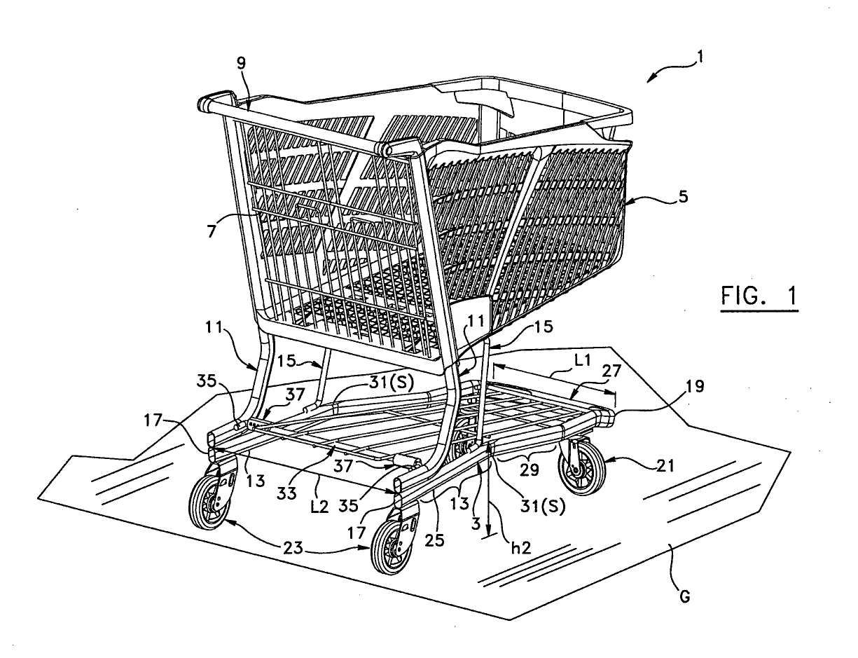

FIG. 1 illustrates a shopping cart (1) according to a preferred embodiment of the invention including a framed wheeled chassis (3) supporting a basket (5).

The basket (5), which can be made of usual materials such as metal, plastic, composites or the like, has a rear wall (7) that swings when two similar shopping carts are nested. The shopping cart is also equipped with a usual handlebar (9) for leading the cart.

Two rear upright supports (11), having the form of bent bars, extend from the rear section (13) of the chassis for supporting the basket (5). Two upright members (15), located between the rear end (17) and the front end (19) of the chassis, also support the basket (5).

The shopping cart includes two front swivel wheels or casters (21) and two rear fixed wheels (23).

In this example, the chassis (3) is a tubular framed chassis including two spaced-apart longitudinal members (25) extending from the rear end (17) to the front end (19) of the chassis (3); and a front cross-bar (27) connecting the two longitudinal members (25) at the front end of the chassis. The front cross-bar (27) forming the front end of the chassis has a width L₂ smaller that the width L₁ of the rear end, thereby allowing two shopping carts to nest. As illustrated on FIG. 1, the frame of the chassis can be made of a unique longitudinal member that has been bent to form the two spaced-apart longitudinal members (25) and the front cross-bar (27).

The chassis has a front end section (29) slopping downwardly from a line of junction (31) between the rear end section (13) and the front end section (29). The line of junction is positioned at a height h₂ above ground level (G).

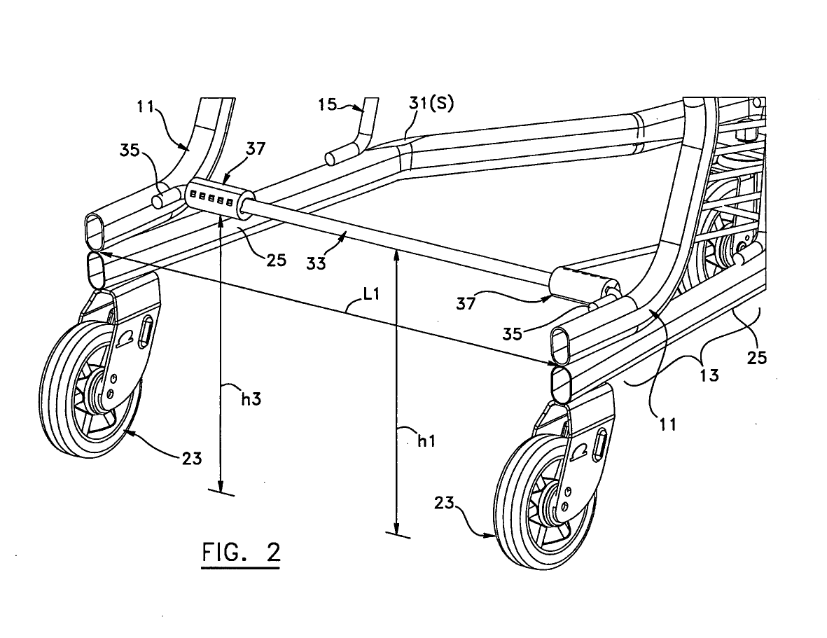

As closely illustrated on FIG. 2, the chassis also includes a rear cross-bar (33) in the rear end section (13) of the chassis. The cross-bar (33) is fixed between the two longitudinal members (25) and has a bottom surface positioned at a height h₁ above ground level (G).

The height h₁ of the cross-bar is greater than the height h₂ of the line of junction, such that when a following similar shopping cart is nested into the shopping cart, the rear cross-bar of the shopping cart passes above the line of junction of the following shopping cart. For doing so, the cross-bar (33) has its both extremities (35) fixed to two upright supports (11). Other configurations for fixing the cross-bar to the rear section of the chassis may be considered, insofar as the height h₁ of the cross-bar is greater than the height h₂ of the line of junction.

Two upright members (15), each one being connected to one of the longitudinal members (25), extend from a point behind the line of junction (31) for stopping the rear cross-bar of the shopping cart (1) when a following shopping cart is nested.

The shopping cart (1) also includes two removable tube-shaped height adapters (37) located at each extremity (35) of the rear cross-bar (33). In this example, the height adapters are two tubes embracing the form of the cross-bar (33).

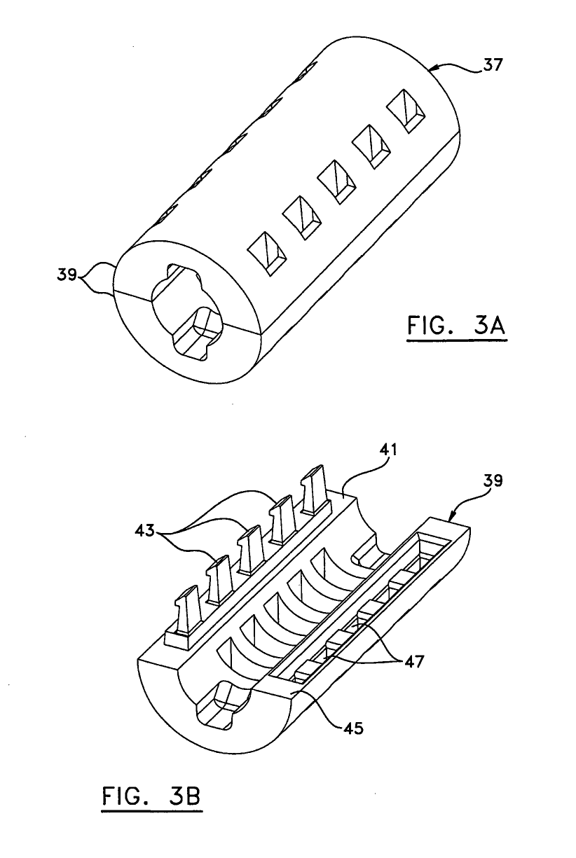

According to the example illustrated on FIG. 3A, each tube is formed by two similar half cylinders (39), such as the one illustrated on FIG. 3B. Each of the two half cylinders (39) include a male planar longitudinal face (41) provided with barbed projections (43) and a female planar longitudinal face (45) provided with recesses (47) sized to tightly receive the barbed projections (43). The two half cylinders (39) are then clippable to each other by connecting the male planar face (41) and female planar face (45) of the first half cylinder to the female planar face (45) and male planar face (41) respectively of the second half cylinder.

The half cylinders (39) are then clipped on the cross-bar (33) to form the tube (37) embracing the rear cross-bar (33b) for reducing, when connected to the rear cross-bar, the height h₁ of the bottom surface of the rear cross-bar to a height h₃ which is smaller than height h₂.

The height adapter of the invention is not limited to the tube shaped adapter clipped to the cross-bar as shown in the illustrated embodiment. Any height adapters allowing the bottom surface of the cross-bar to be reduced from h₁ to h₃ may be used. Hence, the height adapter may alternatively have any geometrical shapes such as square, triangle, semi-spherical, etc. Also, it may be fixed to the cross-bar according to any sort of means as soon as the height adapter is removable.

As aforesaid, the height adapter is preferably made of a plastic such as Nylon® (i.e. polyamides) or ABS (i.e. Acrylonitrile Butadiene Styrene). Other sort of materials can be used given that they allow the tubes to be resistant and the half cylinders to be clippable.

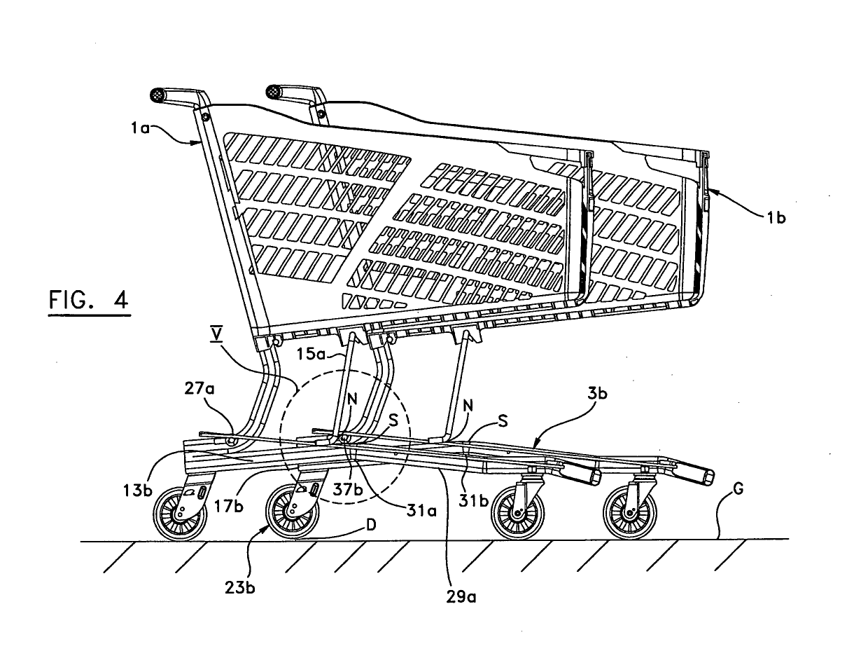

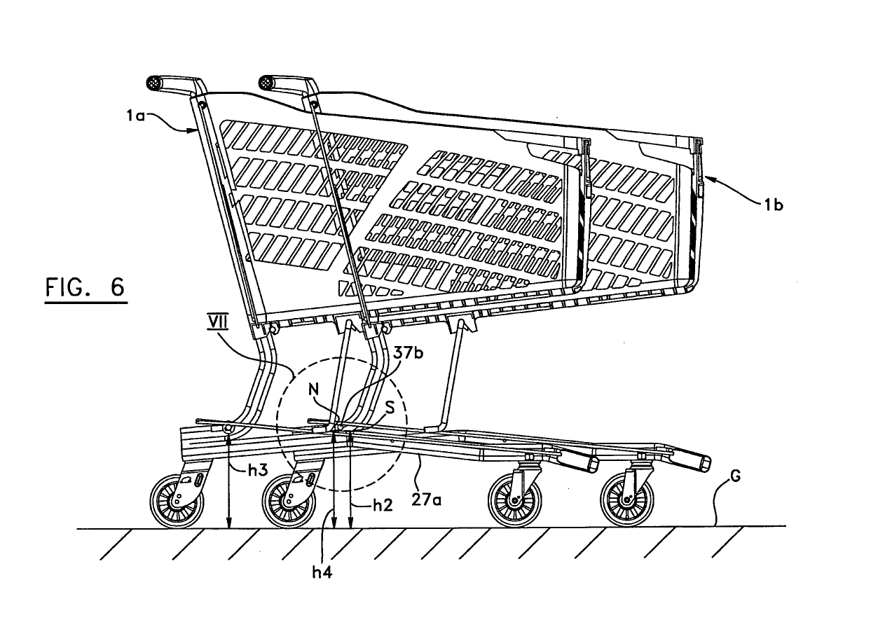

Referring to FIGS. 4 and 6, there are shown two shopping carts (1a and 1b) nested together. For the lack of clarity, the numbering of the elements of FIGS. 4 and 6 is identical to numbering of the elements of FIG. 1, except that it has been associated to the letters (a) or (b), where (a) refers to the rear shopping cart which is nested into the front shopping cart, to which the letter (b) refers. For example, the rear shopping cart (1a) in FIGS. 4 and 6 is nested into the front shopping cart (1b).

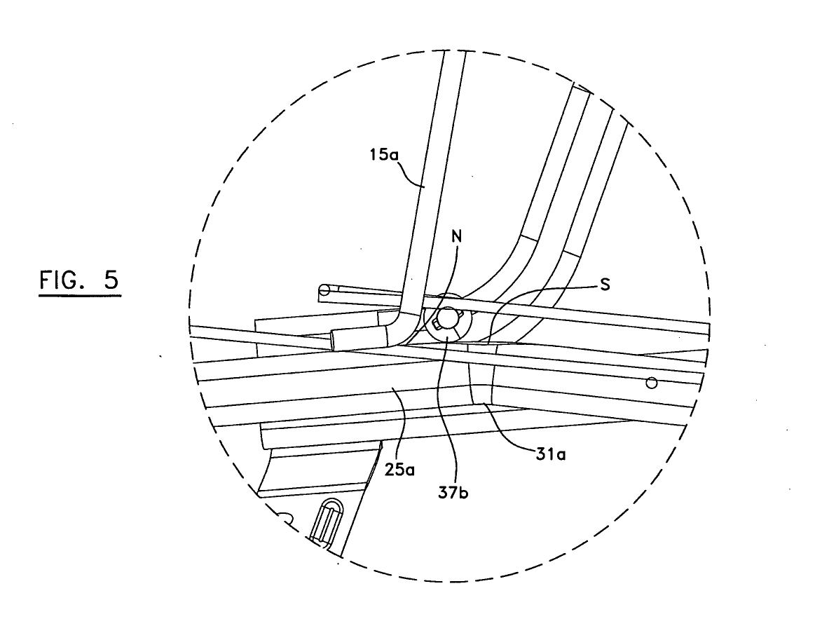

As illustrated on FIGS. 4 and 5, when the tubes (37b) are present at the extremities of the rear cross-bar (33b) of the front cart (1b), the rear end (17b) of the chassis (3b) lifts together with the rear wheels (23b), when the rear shopping cart (1a) is nested into the front shopping cart (1b) and the cross-bar (33b) reaches at least the line of junction (31a) of the rear cart (1a).

According to a preferred embodiment of the invention particularly visible on FIGS. 4 to 7, the rear end section (13b) of the chassis (3) slopes upwardly from the rear end (17b) to the line of junction (31b). As such, the line of junction (31b) between the upward rear end section (13b) and the downward front end section (29b) forms a summit (S), also of height h₂.

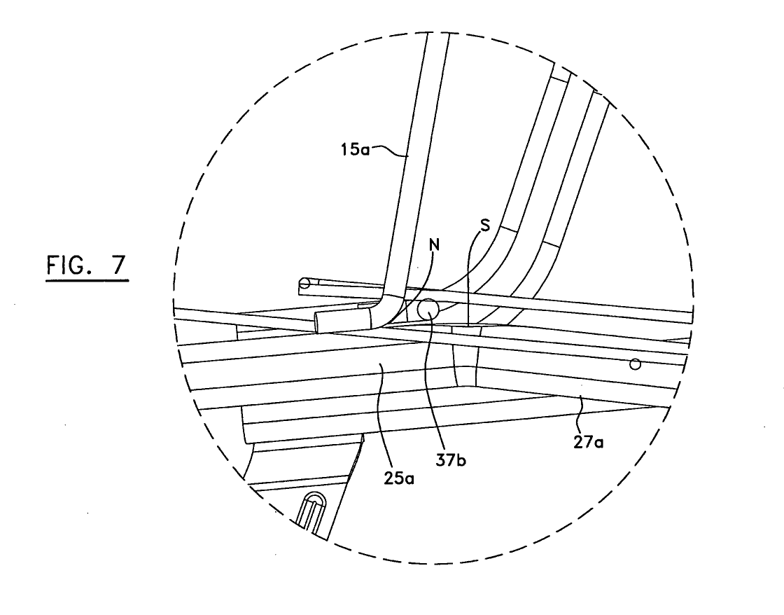

As can be appreciated by viewing FIGS. 5 and 7 is that a niche (N) is defined at the junction where the upright member (15a) is connected, behind the summit (S), to the longitudinal members (25a). Since the longitudinal members (25a) are slopping upward toward the summit, the niche (N) has a height h₄ slightly smaller than h₂ but greater than the height h₃. Therefore, when the cross-bar (33b) of the front cart (1b) reaches the niche (N), it has a tendency to remain there under the effect of gravity.

In FIG. 4, the rear shopping cart (1a) is nested into the front shopping cart (1b), the height adapters (37b) being present on the rear cross-bar (33b). The rear wheels (23b) of the front shopping cart (1b) have been first caused to lift thanks to the height adapter sliding on the slopping front section (29a) of the rear shopping cart (1a), until the height adapters reach the line of junction (31a), or summit (S), of the rear shopping cart (1a). Then, the rear wheels of the front cart are caused to lower down thanks to the rear cross-bar (33b) sliding down on the rear end section (13a) of the rear shopping cart (1a), until they reach and are stopped by the two upright elements (15a) of the rear shopping cart (1a). Then, thanks to the effect of gravity and the fact that the rear end section of the rear shopping cart is rising toward the line of junction, the rear wheels (23b) of the front shopping cart are forced to remain in the lift position.

As well visible on FIG. 4, it has to be understood that the distance (D) between the bottom of rear wheels (23b) and the ground (G) is equal to the difference between h₃ (the height of the bottom surface of the height adapters) and h₄ (the height of the niche). The two nested shopping carts (1a and 1b) are thus temporarily linked together with the rear wheels (23b) of the front shopping cart (1b) remaining elevated until someone forces the disengagement of the two nested carts.

FIG. 6 illustrates when the height adapters have been removed from the rear cross-bar (33b) of the front shopping cart (1b). In that case, when the rear shopping cart (1a) is nested into the front shopping cart (1b), the rear cross-bar (33b) of the front shopping cart (1b) never contacts the longitudinal members (25) of the rear shopping cart (1a), since the height h₁ of the cross-bar (33b) is greater than the height of the line of junction or summit (S) of the rear shopping cart (1a). Therefore, the rear wheels (23b) of the front shopping cart (1b) remain grounded.

By simply removing the tubes (height adapters) clipped to the cross-bar, the shopping cart with lift mechanism is then easily converted to a shopping cart without lift mechanism.

Although the present invention has been explained hereinabove by way of a preferred embodiment thereof, it should be pointed out that any modifications to this preferred embodiment within the scope of the invention is not deemed to alter or change the nature and scope of the present invention.

1. A shopping cart nestable into a preceding similar shopping cart and into which a following similar shopping cart is nestable, the shopping cart comprising:
a wheeled chassis having:
a rear end of width L₁, a rear end section, a front end section sloping downwardly from a line of junction between the rear end section and the front end section and a front end of width L₂ smaller that width L₁; the line of junction being positioned at a height h₂ above ground level; and
a rear cross-bar in the rear end section of the chassis having a bottom surface positioned at a height h₁ above ground level greater than h₂, such that when a following similar shopping cart is nested into the shopping cart, the rear cross-bar passes above the line of junction of the following similar cart; and
a height adapter removably connectable to the cross-bar for reducing, when connected to the cross-bar, the height of the bottom surface of the cross-bar to a height h₃ which is smaller than height h₂ and thereby causing the rear end of the chassis to lift when a following similar shopping cart is nested into the shopping cart and the cross-bar reaches at least the line of junction of the following similar cart.

2. The shopping cart of claim 1, wherein the chassis comprises:
at least one upright member extending from a point located on the rear end section for stopping the rear cross-bar of a preceding similar shopping cart being nested into the shopping cart.

3. The shopping cart of claim 1, wherein the rear end section slopes upwardly from the rear end to the line of junction.

4. The shopping cart according to claim 1, wherein the height adapter is tube-shaped and fixable to the rear cross-bar.

5. The shopping cart according to claim 4, wherein the height adapter comprises two half cylinders that are clippable to each other to form a tube embracing the rear cross-bar.

6. The shopping cart according to claim 5, wherein the two half cylinders are similar and comprises a first and a second half cylinder each comprising a male planar longitudinal face provided with projections and a female planar longitudinal face provided with recesses sized to tightly receive the projections whereby the two half cylinders are clippable to each other by connecting the male planar face and female planar face of the first half cylinder to the female planar face and male planar face respectively of the second half cylinder.

7. The shopping cart according to claim 6, wherein each of the projections is barbed.

8. The shopping cart according to claim 1, wherein said height adapter comprises two of said height adapter, both being removably connectable to a respective extremity of the rear cross-bar.

9. The shopping cart according to claim 1, wherein the height adapter is made of a plastic.

10. A shopping cart nestable into a preceding similar shopping cart and into which a following similar shopping cart is nestable, the shopping cart comprising:
a wheeled chassis having:
a rear end of width L₁, a rear end section, a front end section sloping downwardly from a line of junction between the rear end section and the front end section and a front end of width L₂ smaller that width L₁; the line of junction being positioned at a height h₂ above ground level,
two spaced-apart longitudinal members extending from the rear end to the front end of the chassis;
a front cross-bar connecting the two longitudinal members at the front end of the chassis;
a rear cross-bar in the rear end section of the chassis the two longitudinal members and having a bottom surface positioned at a height h₁ above ground level greater than h₂, such that when a following similar shopping cart is nested into the shopping cart, the rear cross-bar passes above the line of junction of the following similar cart; and
two upright members, each one being connected to one of the longitudinal members and extending from a point behind the line of junction for stopping the rear cross-bar of a preceding similar shopping cart being nested into the shopping cart ; and
two removable tube-shaped height adapters each one being fixable to an extremity of the rear cross-bar, each one of the height adapters comprising two half cylinders that are clippable to each other to form a tube embracing the rear cross-bar for reducing, when connected to the rear cross-bar, the height of the bottom surface of the rear cross-bar to a height h₃ which is smaller than height h₂ and thereby causing the rear end of the chassis to lift when a following similar shopping cart is nested into the shopping cart and the cross-bar reaches at least the line of junction of the following similar cart.
